(19) United States
(12) Patent Application Publication
(10) Pub. No.: US 2014/0069672 A1
(43) Pub. Date: Mar. 13, 2014

(54) Power Tool

(71) Applicants: Hironori Mashiko, Hitachinaka, Ibaraki (JP); Nobuhiro Takano, Hitachinaka, Ibaraki (JP); Tomomasa Nishikawa, Hitachinaka, Ibaraki (JP); Atsushi Nakagawa, Hitachinaka, Ibaraki (JP); Masanori Watanabe, Hitachinaka, Ibaraki (JP); Mizuho Nakamura, Hitachinaka,Ibaraki (JP); Katsuhiro Oomori, Hitachinaka,Ibaraki (JP)

(72) Inventors: Hironori Mashiko, Hitachinaka, Ibaraki (JP); Nobuhiro Takano, Hitachinaka, Ibaraki (JP); Tomomasa Nishikawa, Hitachinaka, Ibaraki (JP); Atsushi Nakagawa, Hitachinaka, Ibaraki (JP); Masanori Watanabe, Hitachinaka, Ibaraki (JP); Mizuho Nakamura, Hitachinaka,Ibaraki (JP); Katsuhiro Oomori, Hitachinaka,Ibaraki (JP)

(73) Assignee: Hitachi Koki Co., Ltd., Tokyo (JP)

(21) Appl. No.: 14/118,035

(22) PCT Filed: Mar. 21, 2012
(86) PCT No.: PCT/JP2012/003305

§ 371 Date: Nov. 15, 2013

(30) Foreign Application Priority Data
May 20, 2011 (JP) 2011-113710
May 20, 2011 (JP) 2011-113864

(51) Int. Cl. B25F 5/00

(52) U.S. Cl. CPC B25F 5/00
USPC 173/47

(57) ABSTRACT

A power tool includes: a motor configured to be driven based on one of a plurality of drive modes; a mode section switch; a control portion. The control portion is configured to operate responsive to a first operation to assign one or more drive modes preselected from the plurality of drive modes to the mode selection switch. A second operation different from the first operation is capable of manipulating the mode selection switch to select one drive mode from the one or more preselected drive modes, the control portion being further configured to control the motor based on the one drive mode selected by the mode selection switch.

### TECHNICAL FIELD

The present invention relates to a power tool, such as an electronic pulse driver, that performs operations based on control programs, and an overwriting system and method for overwriting the control programs used to control the power tool or parameters in the control programs.

### BACKGROUND ART

In assembly work at automobile factories, for example, a wide variety of screws and bolts are used. In such situations, it is desirable to have a tool with specifications suitable for all components. In a conventional power tool known in the art, a hammer is rotated by the torque of a motor to impact an anvil (see Japanese Patent Application Publication No. 2011-31313, for example). This conventional power tool can operate in one of a plurality of control modes, including a pulse mode and an impact mode.

### DISCLOSURE OF INVENTION

### Solution to Problem

However, since the programs stored in the control unit (microcomputer, for example) of this conventional power tool cannot be modified, the power tool cannot always perform operations required to meet the customer's needs. Further, since the conventional power tool can operate in a plurality of control modes, the operator must perform troublesome and time-consuming operations to set up the tool in the desired control mode, even when a dial is provided on the power tool for switching modes. In addition, the control modes used most frequently by the user will differ depending on whether the user primarily tightens screws or primarily tightens bolts. Hence, providing the power tool with a large number of control modes is, in effect, equipping the device with numerous modes that the user does not need.

In view of the foregoing, it is an object of the present invention to provide a power tool capable of operating based solely on the control modes required by the user. It is another object of the present invention to provide a power tool capable of overwriting control programs in the control unit or parameters used by the programs, and an overwriting system and method for overwriting the control programs provided in the power tool or the parameters used by the control programs.

In order to attain the above and other objects, the invention provides a power tool including: a motor configured to be driven based on one of a plurality of drive modes; a mode section switch; a control portion configured to operate responsive to a first operation to assign one or more drive modes preselected from the plurality of drive modes to the mode selection switch, a second operation different from the first operation being capable of manipulating the mode selection switch to select one drive mode from the one or more preselected drive modes, the control portion being further configured to control the motor based on the one drive mode selected by the mode selection switch.

It is preferable that the first operation is configured to be executed on an external device connected to the power tool.

Another aspect of the present invention provides a power tool including: a motor; a bit drive portion configured to be driven by the motor to drive a bit; a first storing portion configured to store a plurality of control modes for controlling the motor; and a control portion configured to control the motor. The power tool further includes a second storing portion configured to store one or more control modes selected from the plurality of control modes as one or more drive modes. The control portion is configured to control the motor based on one drive mode selected from the one or more drive modes stored in the second storing portion.

It is preferable that the power tool further including a connection portion configured to be connectable to an external device to conduct communication between the power tool and the external device. The external device connected to the connection portion is configured to transmit one or more control modes selected from the plurality of control modes. The second storing portion is configured to store the one or more control modes transmitted from the external device as the one or more drive modes.

Another aspect of the present invention provides a power tool including: a housing; a control portion accommodated in the housing; and a connection unit including a cable that is configured to be connectable to an external overwriting unit to conduct communication between the control portion and the external overwriting unit. The connection unit is configured to connect the external overwriting unit with the control portion to execute both of power supply and signal transmission from the external overwriting unit to the control portion.

It is preferable that one side of the connection unit connected to the external overwriting unit includes two systems including a power supply system and a communication system.

It is preferable that the power supply system includes a USB cable.

It is preferable that the communication system includes an RS232C cable.

It is preferable that the control portion includes an M16C/64 CPU.

It is preferable that the connection unit includes a conversion portion including a transmission integrated circuit.

It is preferable that the transmission integrated circuit is a bus transceiver.

It is preferable that the conversion portion is provided outside the housing.

It is preferable that the connection unit includes a single cable connecting the conversion portion with the control portion. The single cable includes one signal line for the power supply and another signal line for the signal transmission.

It is preferable that the housing is provided with a communication connector. The single cable is configured to be detachable with respect to the communication connector.

It is preferable that the connection unit includes a cable connecting the conversion portion with the external overwriting unit. The cable includes two systems including a power supply system and a communication system.

It is preferable that the connecting unit is configured to be detachable with respect to the housing.

Another aspect of the present invention provides an overwriting system including: a power tool including: a housing; and a control portion accommodated in the housing; a computer; and a connection unit configured to connect the power tool with the computer to conduct communication between the computer and the control portion. The computer is configured to supply power to the control portion through the connection unit and to overwrite program used in the control portion or parameter in the program through the connection unit.

Another aspect of the present invention provides an overwriting method including:

connecting one end of a connection unit to a communication connector of a power tool including a control portion; connecting another end of the connection unit to a computer to conduct communication between the computer and the control portion; and supplying power from the computer to the control portion through the connection unit and overwriting program used in the control portion or parameter in the program through the connection unit.

### Advantageous Effects of Invention

According to the power tool, the power tool can operate based solely on the control modes required by the user. Further, according to the power tool, the overwriting system, and the overwriting method, a power tool can overwrite control programs in the control unit or parameters used by the programs.

### BRIEF DESCRIPTION OF DRAWINGS

FIG. 1 is an external perspective view of an electronic pulse driver according to a first embodiment of the present invention;

FIG. 2 is a cross-sectional view of the electronic pulse driver according to the first embodiment of the present invention;

FIG. 3 is a control block diagram of the electronic pulse driver according to the first embodiment of the present invention;

FIG. 4 is a diagram showing a state where a main body of the electronic pulse driver and a PC are connected with each other;

FIG. 5 is a flowchart illustrating steps in a process for changing drive modes according to the first embodiment of the present invention;

FIG. 6 is a diagram showing a GUI window for changing drive modes according to the first embodiment of the present invention;

FIG. 7 shows an overall appearance of an electronic pulse driver and an overwriting system according to a second embodiment of the present invention;

FIG. 8 is a block diagram illustrating the electrical structure of the overwriting system according to a second embodiment of the present invention;

FIG. 9 is a side view of an electronic pulse driver according to the second embodiment of the present invention;

FIG. 10 is a cross-sectional view of the electronic pulse driver according to the second embodiment of the present invention;

FIG. 11 is an enlarged perspective view of a connecting member of the electronic pulse driver according to the second embodiment of the present invention;

FIG. 12 is a block diagram illustrating the electrical structure of the overwriting system according to a modification to the second embodiment of the present invention;

### REFERENCE SIGNS LIST

1 electronic pulse driver

2 housing

3 motor

30 toggle switch

78 microcomputer

80 EEPROM

82 PC

83 USB cable

100 overwriting system

103 computer

104 power cable

105 communication cable

106 conversion device

108 dedicated cable

201 power tool

### DESCRIPTION OF EMBODIMENTS

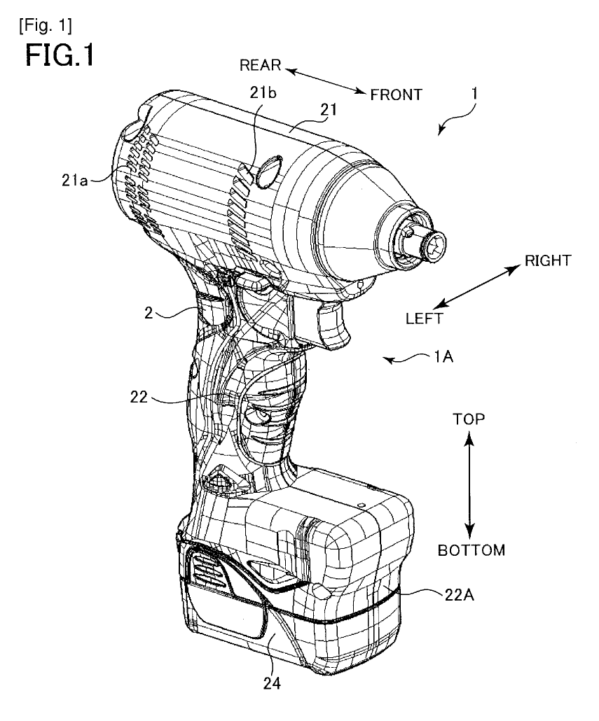

Next, the structure of a power tool according to a first embodiment of the present invention will be described while referring to FIGS. 1 through 3. The power tool according to the first embodiment is an electronic pulse driver 1.

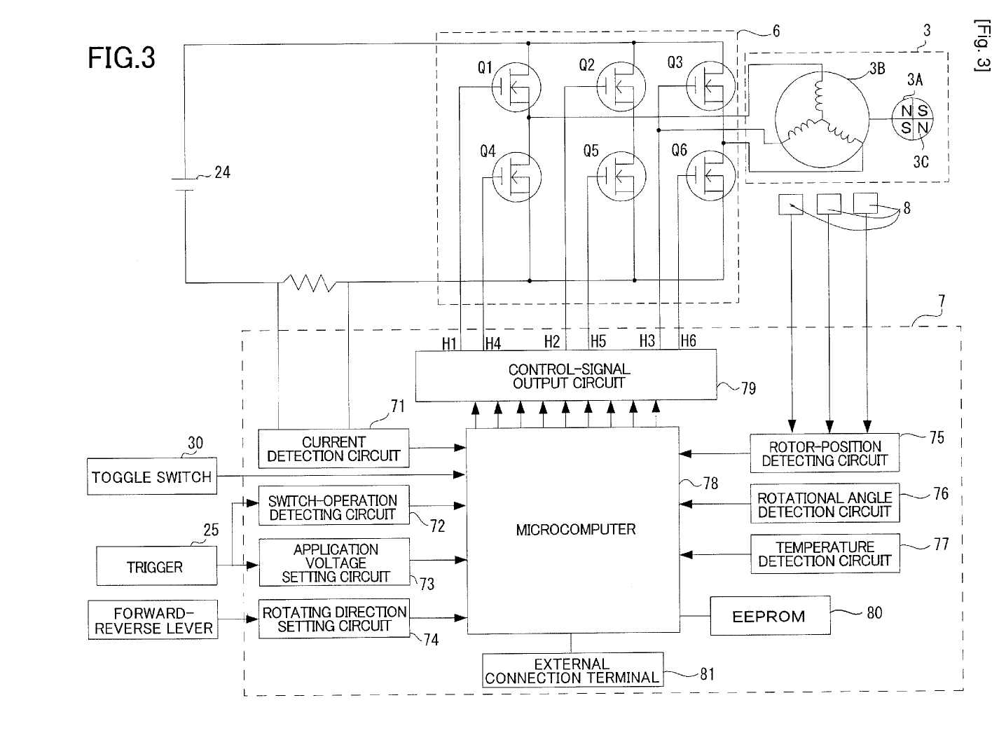

As shown in FIG. 1, the electronic pulse driver 1 is configured of a main body 1A, and a battery 24. The main body 1A primarily includes a housing 2, a motor 3, a hammer unit 4, an anvil unit 5, an inverter circuit 6, a control unit 7, and rotational position sensors (Hall elements) 8 (see FIG. 3).

The housing 2 is formed of a resin material and constitutes the outer shell of the electronic pulse driver 1. The housing 2 is primarily configured of a substantially cylindrical body section 21, and a handle section 22 extending from the body section 21.

The motor 3 is disposed inside the body section 21 and is oriented with its axial direction running in the longitudinal direction of the body section 21. The hammer unit 4 and anvil unit 5 are juxtaposed and positioned to confront one axial end of the motor 3. In the following description, the side in which the anvil unit 5 is disposed is defined as the front side of the electronic pulse driver 1 while the side possessing the motor 3 is defined as the rear side, and directions parallel to the axis of the motor 3 are defined as forward and rearward directions. Additionally, the body section 21 side of the electronic pulse driver 1 will be defined as the top side of the electronic pulse driver 1, the handle section 22 side as the bottom side, and the vertical direction as the direction extending between the body section 21 and handle section 22. Further, directions orthogonal to the forward and rearward directions and the upward and downward directions are defined as left and right directions.

A hammer case 23 is disposed at a forward position within the body section 21 for housing the hammer unit 4 and anvil unit 5. The hammer case 23 is formed of metal in a general funnel shape such that its diameter grows gradually narrower toward the front end. An opening 23a is formed in the front end of the hammer case 23. The hammer case 23 also has a metallic part 23A provided on the inner wall thereof defining the opening 23a.

Also formed in the body section 21 is a plurality of intakes 21a and outlets 21b through which external air is drawn into and discharged from the body section 21 by a fan 32 described later. The external air flowing through the body section 21 cools the motor 3. The inverter circuit 6 is also provided on the rear side of the motor 3.

The handle section 22 is integrally configured with the body section 21 and extends downward from a position on the body section 21 in substantially the front-to-rear center thereof. A battery connector 22A is provided on the bottom end of the handle section 22. The battery 24 is detachably mounted on the battery connector 22A and functions to supply power to the motor 3 and the like. The battery 24 is a nickel-cadmium battery or a lithium-ion battery, for example. A trigger 25 is provided in the top portion of the handle section 22 and is positioned on the front side thereof. A toggle switch 30 (FIG. 3) as a mode selection switch is provided in the bottom portion of the handle section 22 on the right side surface thereof and functions to switch the operating mode of the electronic pulse driver 1 among four drive modes described later. A display unit (not shown) is also disposed near the toggle switch 30 for displaying the drive mode that is currently selected.

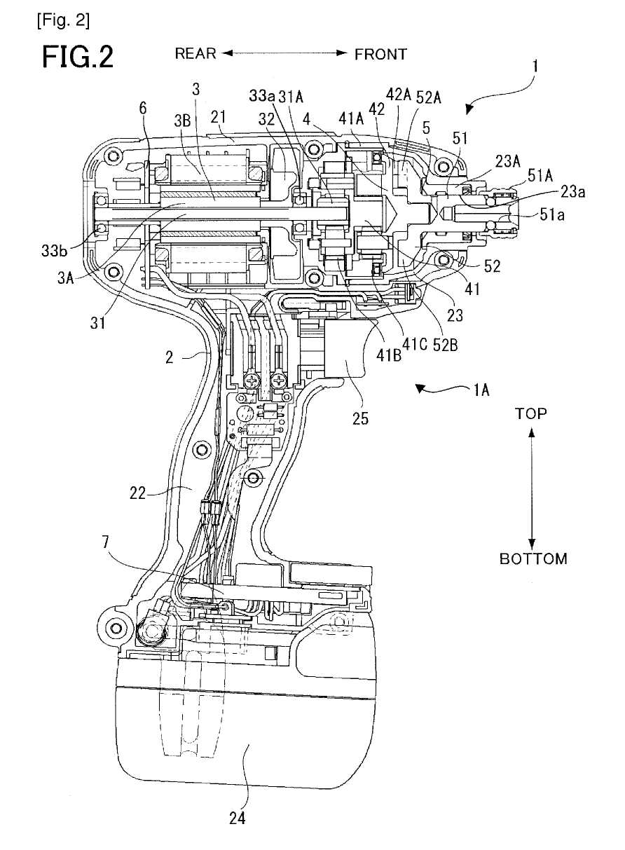

As shown in FIG. 2, the motor 3 is a brushless motor primarily configured of a rotor 3A including an output shaft 31, and a stator 3B disposed in confrontation with the rotor 3A. The motor 3 is arranged in the body section 21 so that the axis of the output shaft 31 is oriented in the front-to-rear direction. The output shaft 31 protrudes from both front and rear ends of the rotor 3A and is rotatably supported in the body section 21 at the protruding ends by bearings 33a and 33b. A fan 32 is disposed on the portion of the output shaft 31 protruding forward from the rotor 3A. The fan 32 rotates integrally and coaxially with the output shaft 31. A pinion gear 31A is provided on the forwardmost end of the portion of the output shaft 31 protruding forward from the rotor 3A. The pinion gear 31A rotates integrally and coaxially with the output shaft 31.

The hammer unit 4 is housed in the hammer case 23 on the front side of the motor 3. The hammer unit 4 primarily includes a gear mechanism 41, and a hammer 42. The gear mechanism 41 includes a single outer gear 41A, and two planetary gear mechanisms 41B and 41C that share the same outer gear 41A. The outer gear 41A is housed in the hammer case 23 and fixed to the body section 21. The planetary gear mechanism 41B is disposed in the outer gear 41A and is engaged with the same. The planetary gear mechanism 41B uses the pinion gear 31A as a sun gear. The planetary gear mechanism 41C is also disposed in the outer gear 41A and is engaged with the same. The planetary gear mechanism 41C is positioned forward of the planetary gear mechanism 41B and uses the output shaft of the planetary gear mechanism 41B as a sun gear.

The hammer 42 is defined in the front surface of a planetary carrier constituting the planetary gear mechanism 41C. The hammer 42 includes a first engaging protrusion 42A disposed at a position offset from the rotational center of the planet carrier and protruding forward, and a second engaging protrusion (not shown) disposed on the opposite side of the rotational center of the planet carrier from the first engaging protrusion 42A.

The anvil unit 5 is disposed in front of the hammer unit 4 and primarily includes a tip tool mounting part 51, and an anvil 52. The tip tool mounting part 51 is cylindrical in shape and rotatably supported in the opening 23a of the hammer case 23 through the metallic part 23A. An insertion hole 51a penetrates the tip tool mounting part 51 in the front-to-rear direction for receiving a bit (not shown) inserted therethrough. A chuck 51A is provided at the front end of the tip tool mounting part 51 for holding the bit.

The anvil 52 is disposed in the hammer case 23 on the rear side of the tip tool mounting part 51 and is integrally formed with the tip tool mounting part 51. The anvil 52 includes a first engagement protrusion 52A and a second engagement protrusion 52B respectively disposed on opposite sides of the rotational center of the tip tool mounting part 51. The engagement protrusions 52A and 52B protrude rearward from the anvil 52. When the hammer 42 rotates, the first engaging protrusion 42A collides with the first engagement protrusion 52A at the same time the second engagement protrusion (not shown) collides with the second engagement protrusion 52B, transmitting the torque of the hammer 42 to the anvil 52.

As shown in FIG. 3, the inverter circuit 6 includes six switching elements Q1-Q6 configured of FETs or the like connected in a 3-phase bridge configuration.

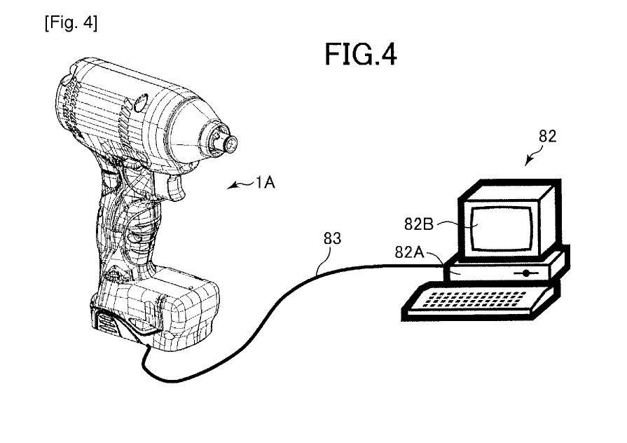

The control unit 7 is mounted on a circuit board provided in the handle section 22 at a position near the battery 24. The control unit 7 is connected to the battery 24, as well as the trigger 25, the inverter circuit 6, the toggle switch 30, and the display unit (not shown). As shown in FIG. 3, the control unit 7 includes a current detection circuit 71, a switch operation detection circuit 72, an applied voltage setting circuit 73, a rotating direction setting circuit 74, a rotor position detection circuit 75, a rotational angle detection circuit 76, a temperature detection circuit 77, a microcomputer 78 as a calculating section, a control signal output circuit 79, a EEPROM 80, and an external connection terminal (communication connector) 81. The external connection terminal 81 is provided on the portion of the handle section 22 that confronts the battery 24 and is exposed when the battery 24 is removed. The external connection terminal 81 is connected to the microcomputer 78 in the main body 1A, enabling an external device, such as a PC 82 (see FIG. 4), to connect to and communicate with the microcomputer 78. The external connection terminal 81 is any common connector, such as a Micro-USB connector.

The rotational position sensors 8 are disposed at positions facing permanent magnets 3C in the rotor 3A. The rotational position sensors 8 are spaced at prescribed intervals along the circumferential direction of the rotor 3A (every 60 degrees, for example).

Next, the structure of a control system for driving the motor 3 will be described with reference to FIG. 3. In this embodiment, the motor 3 is configured of a 3-phase brushless DC motor. The rotor 3A of this motor 3 is configured of a plurality (two in this embodiment) of the permanent magnets 3C, each having an N-pole and an S-pole. The stator 3B is configured of 3-phase star-connected stator coils U, V, and W.

The gates of the switching elements Q1-Q6 constituting the inverter circuit 6 are connected to the control signal output circuit 79 of the control unit 7, while the drains or sources of the switching elements Q1-Q6 are connected to the stator coils U, V, and W of the stator 3B. The switching elements Q1-Q6 perform switching operations based on switching element drive signals inputted from the control signal output circuit 79 and supply power to the stator coils U, V, and W by converting the DC voltage of the battery 24 applied to the inverter circuit 6 to 3-phase (U-phase, V-phase, and W-phase) voltages Vu, Vv, and Vw. More specifically, output switching signals H1, H2, and H3 inputted from the control signal output circuit 79 into the switching elements Q1-Q3 on the positive power supply side of the inverter circuit 6 control to which of the stator coils U, V, and W power is supplied and, hence, the rotating direction of the rotor 3A. The pulse width modulation (PWM) signals H4, H5, and H6 inputted from the control signal output circuit 79 into the switching elements Q4-Q6 on the negative power supply side of the inverter circuit 6 control the amount of power supplied to the stator coils U, V, and W and, hence, the rotational speed of the rotor 3A.

The current detection circuit 71 measures the current supplied to the motor 3 and outputs this value to the microcomputer 78. The switch operation detection circuit 72 detects whether the trigger 25 has been operated and outputs the results of this detection to the microcomputer 78. The applied voltage setting circuit 73 outputs a signal to the microcomputer 78 commensurate with the degree to which the trigger 25 was operated.

The electronic pulse driver 1 is also provided with a forward-reverse lever (not shown) for toggling the rotating direction of the motor 3. The rotating direction setting circuit 74 detects changes in the forward-reverse lever and transmits a signal to the microcomputer 78 to toggle the rotating direction of the motor 3.

The rotor position detection circuit 75 detects the rotational position of the rotor 3A based on signals received from the rotational position sensors 8 and outputs the detected position to the microcomputer 78.

The rotational angle detection circuit 76 detects the angle of the rotor 3A based on signals received from the rotational position sensors 8. The detection value of the rotational angle detection circuit 76 is used when performing control based on the rotational angle. The temperature detection circuit 77 detects the temperature of the motor 3. The microcomputer 78 is configured to halt rotation of the motor 3 when the temperature of the motor 3 rises to a predetermined value.

While not shown in the drawings, the microcomputer 78 is configured of a central processing unit (CPU) for outputting a drive signal based on a program and control data, a ROM for storing the program and control data, a RAM for temporarily storing process data, and a timer. The microcomputer 78 generates the output switching signals H1, H2, and H3 based on signals outputted from the rotating direction setting circuit 74 and rotor position detection circuit 75 and generates the PWM signals H4, H5, and H6 based on signals outputted from the applied voltage setting circuit 73, and outputs these signals to the control signal output circuit 79. Here, the microcomputer 78 may output the PWM signals to the switching elements Q1-Q3 on the positive power supply side and may output the output switching signals to the switching elements Q4-Q6 on the negative power supply side.

In this embodiment, twenty control modes (control programs) for controlling the motor 3 are stored in the ROM of the microcomputer 78. Four of the twenty control modes stored in ROM are also stored in the EEPROM 80 as drive modes. More specifically, numbers are assigned to each of the twenty control modes stored in ROM, and the four numbers corresponding to four of the control modes are stored in the EEPROM 80. Of these four drive modes, the drive mode currently selected by the toggle switch 30 is displayed on the display unit as the current drive mode. The CPU of the microcomputer 78 reads the control mode corresponding to the selected drive mode from ROM in order to control the motor 3.

Next, the twenty control modes stored in the ROM of the microcomputer 78 will be described. In this embodiment, the electronic pulse driver 1 includes a drill mode, clutch modes 1-10, torque control modes 1-5, and pulse modes 1-4, for a total of twenty control modes.

In the drill mode, the hammer 42 and anvil 52 are rotated as a unit. Therefore, this mode is primarily used for tightening wood screws and the like. In this mode, the microcomputer 78 increases the supply of electric current to the motor 3 as the screw becomes tighter.

In the clutch mode, the current supplied to the motor 3 is gradually increased while the hammer 42 and anvil 52 are rotated together, and the microcomputer 78 halts driving of the motor 3 when the current reaches a target value (target torque). The clutch mode is primarily used when emphasizing a proper tightening torque, such as when tightening cosmetic fasteners or the like that remain visible on the exterior of the workpiece after the fastening operation. In this, ten clutch modes are provided for various tightening forces (target torque values).

In the torque control mode, the electric current supplied to the motor 3 is gradually increased while the hammer 42 and anvil 52 are rotated together, and when the current reaches a prescribed value (prescribed torque), the microcomputer 78 will begin an impact operation by alternating between forward and reverse rotation of the motor 3. The microcomputer 78 stops driving the motor 3 after a prescribed number of impacts. The torque control mode is used when a higher torque than that delivered in the clutch mode is required for tightening the fasteners or the like. The electronic pulse driver 1 according to this embodiment is provided with five torque control modes.

In the pulse mode, the electric current supplied to the motor 3 is gradually increased while the hammer 42 and anvil 52 are rotated together. After the electric current has risen to a prescribed value (prescribed torque), the microcomputer 78 begins producing impacts to tighten the fastener by alternating the motor 3 between the forward and reverse directions. The pulse mode is mainly used when tightening long screws in areas of a workpiece that will not be outwardly visible. This mode can simultaneously supply a strong tightening force while reducing the reaction force from the workpiece. In this embodiment, the electronic pulse driver 1 is provided with four pulse modes corresponding to various tightening forces (prescribed torque values).

Next, the method in which a user selects four of the twenty control modes to be stored in the EEPROM 80 as the four drive modes will be described with reference to FIGS. 4 through 6. First, the user removes the battery 24 from the electronic pulse driver 1 and connects the main body 1A to the PC 82 using a USB cable 83, as illustrated in FIG. 4. On the main body 1A side, the USB cable 83 is connected to the external connection terminal 81. The USB cable 83 enables the PC 82 to supply electricity to the main body 1A. As shown in FIG. 4, the PC 82 includes a computer case 82A provided with a CPU, a ROM, a RAM, and the like; and a display 82B. An application program for setting drive modes is pre-stored in the ROM of the PC 82.

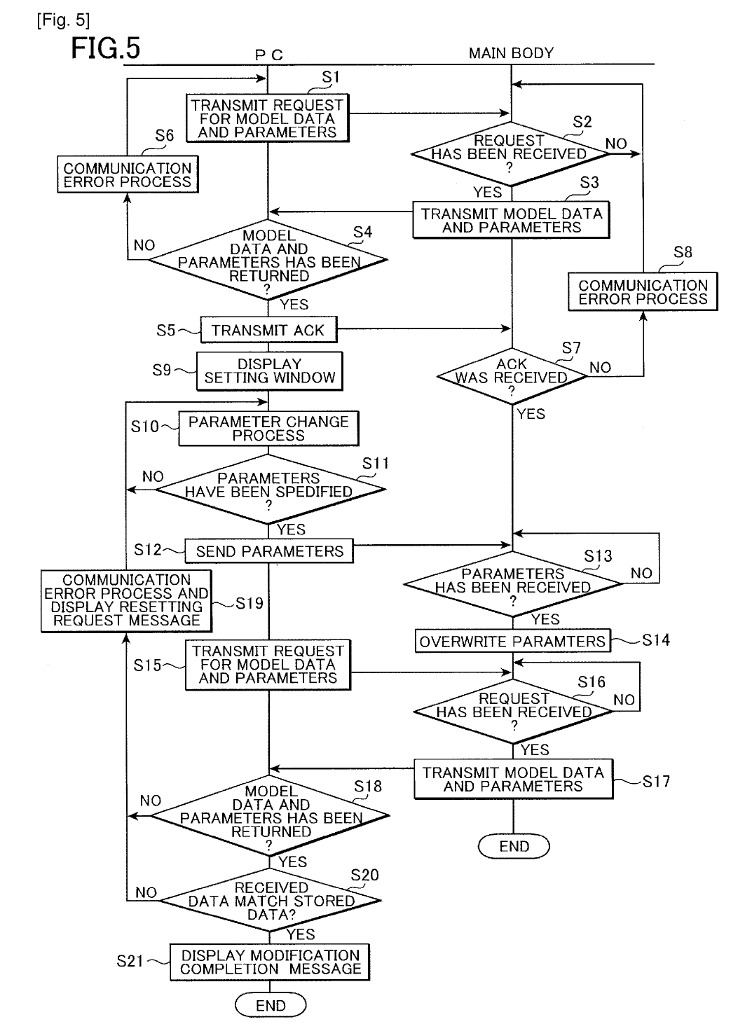

After connecting the main body 1A to the PC 82, the user launches the application program stored in the PC 82. When the application program is started, in Si of FIG. 5 the CPU of the PC 82 (hereinafter “the CPU of the PC 82” will be abbreviated as “the PC 82”) transmits a request to the main body 1A for model data and parameters for electronic pulse driver 1. The model data is the model name of the electronic pulse driver 1 and is stored in the ROM of the microcomputer 78, while the parameters indicate the four drive modes stored in the EEPROM 80.

In S2 the CPU of the main body 1A (hereinafter “the CPU of the main body 1A” will be abbreviated as “the main body 1A”) continually monitors the connection with the PC 82 after the connection has been established to determine whether a request was received. When the main body 1A determines that a request has been received from the PC 82 (S2: YES), in S3 the main body 1A transmits the model data and parameters to the PC 82. The main body 1A continually monitors the connection while a request has not been received (S2: NO).

When a prescribed time has elapsed after the PC 82 transmitted the request in S1, in S4 the PC 82 determines whether model data and parameters have been returned from the main body 1A. If the data has been returned (S4: YES), in S5 the PC 82 transmits an acknowledgment (ACK) to the main body 1A and stores the received model data in RAM. If the PC 82 has not received a response within the prescribed time (S4: NO), in S6 the PC 82 performs a communication error process and returns to S1. The process in S6 may involve incrementing the number of transmission failures that have occurred, for example. If the number of transmission failures reaches a prescribed number, the PC 82 may issue an error notification to the user indicating that the transmission failed.

Also, a prescribed time after the main body 1A returns the model data and parameters in S3, in S7 the main body 1A determines whether an acknowledgment was received from the PC 82. If no acknowledgment was received (S7: NO), in S8 the main body 1A performs a transmission error process similar to the process performed by the PC 82 in S6 and returns to S2. In addition to the performing the transmission error process in S8, the main body 1A also transmits a message to the PC 82 requesting that the process be repeated from S1.

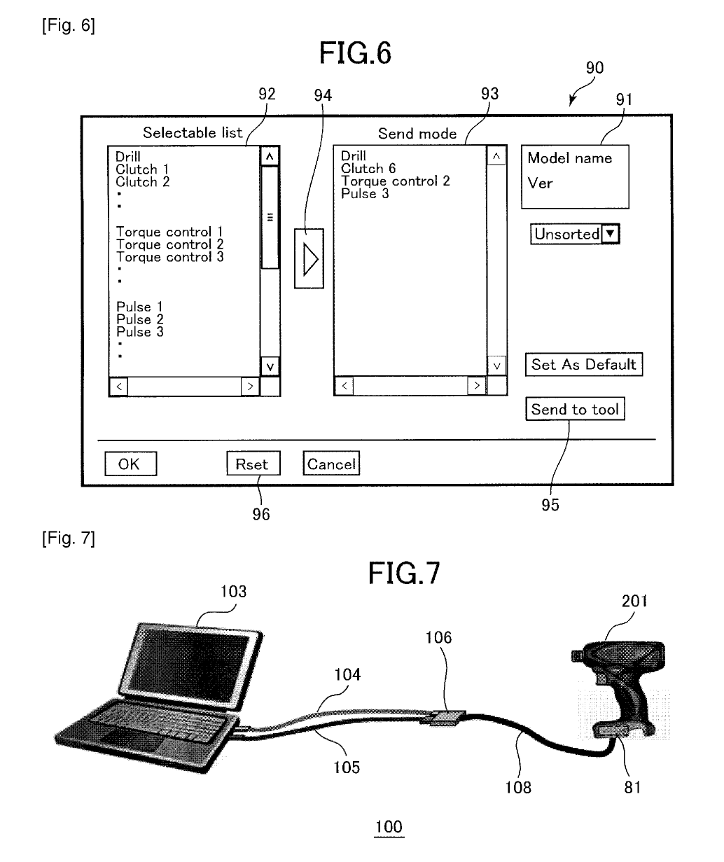

After the PC 82 transmits an acknowledgment in S5 and when a message is not received from the main body 1A indicating a transmission error, in S9 the PC 82 displays a graphical user interface (GUI) window (setting window) 90 on the PC 82. As shown in FIG. 6, the GUI window 90 has a model name display area 91, a control mode list display area 92, a send mode display area 93, a select button 94, a send button 95, and a reset button 96.

The model name and other data on the electronic pulse driver 1 is displayed in the model name display area 91 based on the received model data. A list of the twenty control modes possessed by the electronic pulse driver 1 is displayed in the control mode list display area 92 based on the same model data. The current control modes of the electronic pulse driver 1 (drive modes) are displayed in the send mode display area 93 based on the received parameters. By displaying the GUI window 90, the PC 82 enables the user to modify the control modes in the send mode display area 93.

At this time, the user can select one of the four control modes displayed in the send mode display area 93 and delete the selected mode by clicking the reset button 96. In addition, the user can select one of the control modes in the list of twenty control modes displayed in the control mode list display area 92 and click on the select button 94 to display the selected control mode in the send mode display area 93. In this embodiment, the user can select four control modes to be displayed in the send mode display area 93. After the user has selected four control modes one at a time, the user clicks on the send button 95 to transmit the four control modes from the PC 82 to the main body 1A as parameters (drive modes). In this embodiment, the numbers assigned to these four control modes are transmitted to the main body 1A as the parameters. This drive mode selection process corresponds to a first operation.

Hence, after displaying the GUI window 90 so that the user can modify control modes in the send mode display area 93, in S11 the PC 82 determines whether four control modes (parameters) have been specified. That is, the PC 82 determines whether the user has clicked on the send button 95. While the user has not clicked on the send button 95 (S11: NO), the PC 82 repeatedly loops between the processes in S10 and S11. When the user clicks on the send button 95 and the PC 82 determines that the parameters have been specified (S11: YES), in S12 the PC 82 sends the parameters to the main body 1A. The PC 82 also stores the transmitted parameters in RAM in association with the model data received from the main body 1A.

In the meantime, after the main body 1A receives an acknowledgment from the PC 82 (S7: YES), in S13 the main body 1A determines whether parameters have been received from the PC 82. When parameters have been received from the PC 82 (S13: YES), in S14 the main body 1A overwrites the parameters currently stored in the EEPROM 80 with the new parameters received from the PC 82. While the main body 1A has not received the parameters (S13: NO), the main body 1A repeats determination of S13.

After the PC 82 transmits the parameters in S12, in S15 the PC 82 again transmits a request to the main body 1A for model data and parameters. After writing the parameters to the EEPROM 80 in S14, in S16 the main body 1A determines whether a request has been received from the PC 82. If a request was received from the PC 82 (S16: YES), in S17 the main body 1A transmits the model data and parameters to the PC 82. In the meantime, after transmitting the request in S15, in S18 the PC 82 determines whether the main body 1A has returned the model data and parameters. If there was no reply from the main body 1A (S18: NO), in S19 the PC 82 performs a transmission error process similar to that in S6 and displays on the display 82B a message indicating that the new settings were not successfully modified and a message prompting the user to reselect the desired drive modes, and subsequently returns to S10.

However, if a reply was received in S18 (S18: YES), in S20 the PC 82 determines whether the model data and parameters received from the main body 1A match the model data and parameters stored in the RAM of the comput Ser case 82A. If the data matches (S20: YES), in S21 the PC 82 displays a message on the display 82B indicating that the parameters (drive modes) have been successfully modified, and subsequently ends the process in FIG. 5. However, if the data does not match (S20: NO), the PC 82 performs the process in S19 described above and subsequently returns to S10.

Through the process described above, the four control modes selected by the user are stored in the EEPROM 80 of the electronic pulse driver 1 as the drive modes. In other words, the four control modes are assigned to the toggle switch 30 as the drive modes. Then, one drive mode of the four drive modes is selected by manipulating the toggle switch 30. The electronic pulse driver 1 is driven based on the one selected drive mode currently selected by the toggle switch 30. This drive mode selection process corresponds to a second operation. Hence, the user can operate the electronic pulse driver 1 according to control modes that the user has selected. In this way, this embodiment provides an electronic pulse driver 1 that meets the user's needs. Further, these drive modes can be changed by connecting the main body 1A to the PC 82, as described above. Hence, since it is not necessary to provide a display and button for assigning the drive mode to the toggle switch 30, a compact power tool can be provided.

Next, an overwriting system 100 according to a second embodiment of the present invention will be described. The overwriting system 100 functions to overwrite control programs or the like.

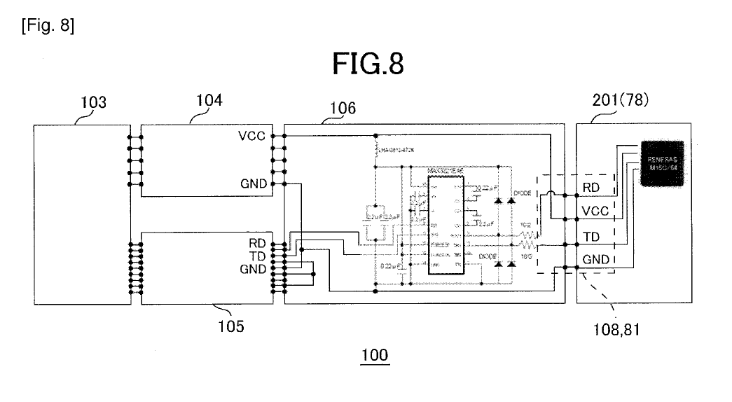

FIG. 7 shows the overall appearance of the overwriting system 100, and FIG. 8 is a block diagram illustrating the electrical structure of the overwriting system 100. In FIG. 7, the battery 24 functioning as the drive source of a power tool 201 has been removed therefrom. In the following description, “program parameters” denote variables that can affect the operations of the control programs, for example, and the term “control programs or the like” will be used to mean “control programs or program parameters. ”

As shown in FIGS. 7 and 8, the overwriting system 100 for overwriting control programs or the like includes the power tool 201, a computer 103, a power cable 104, a communication cable 105, a conversion device 106, and a dedicated cable 108.

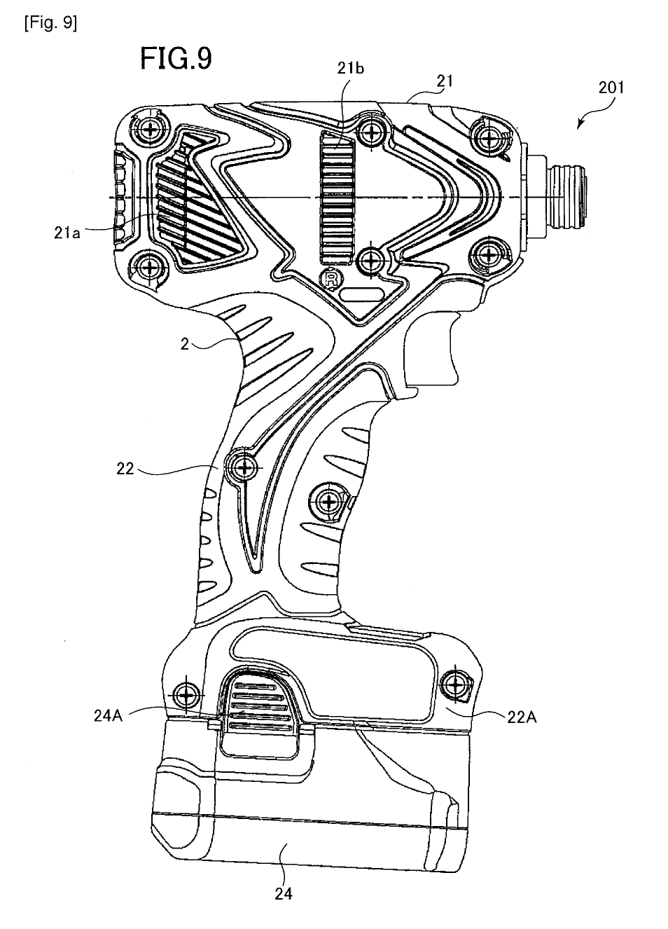

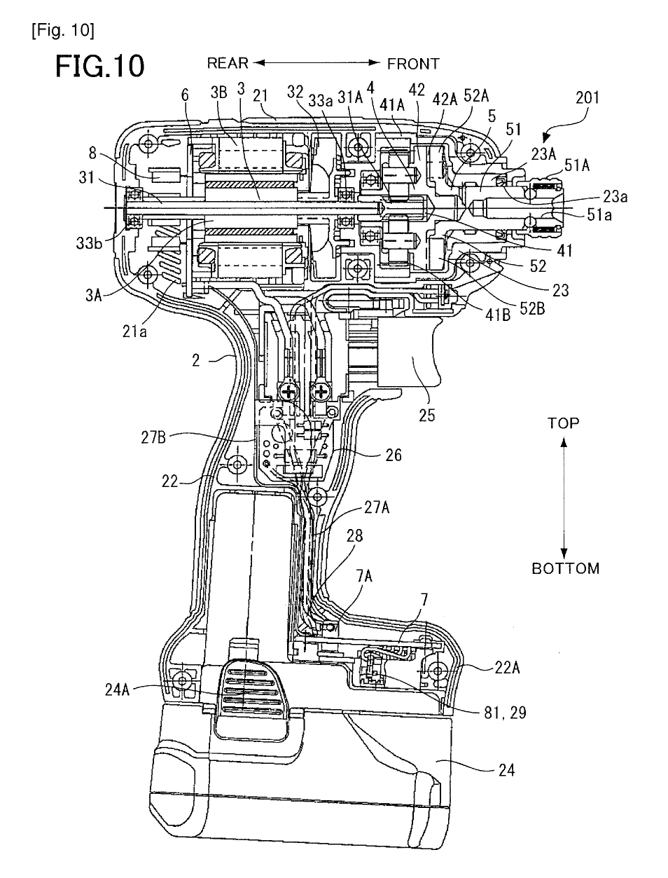

The power tool 201 according to this embodiment will be described with reference to FIGS. 9 and 10, where parts and components similar to the electronic pulse driver 1 of the first embodiment are designated with the same reference numerals to avoid duplicating description.

A switching board 26 is provided beneath the trigger switch 25. The switching board 26 is connected to the control unit 7 via a switch flat cable 27A. The switch flat cable 27A is configured of eighteen flexible printed circuits (FPC), for example.

The control unit 7 is connected to the inverter circuit 6 via a motor flat cable 27B. The motor flat cable 27B is similarly configured of FPCs. The control unit 7 is also provided with a terminal 7A in contact with the plus and minus electrodes of the battery 24. One end of a power line 28 is connected to the terminal 7A, while the other end is a connected to the switching board 26. The power line 28 is provided with one positive and one negative wire.

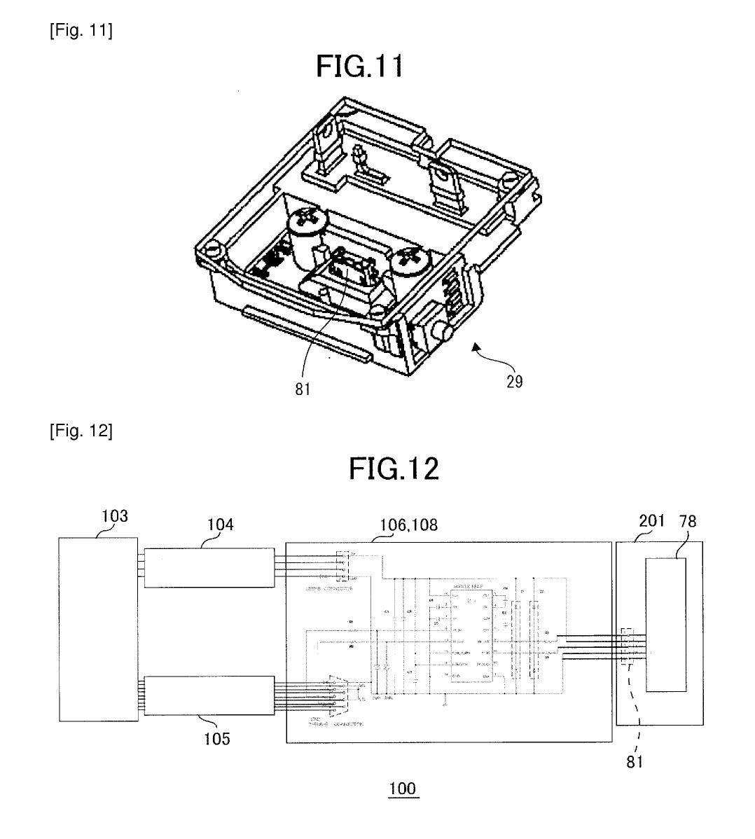

The battery 24 of this embodiment is substantially L-shaped in a side view. The battery 24 extends into and is accommodated in the lower end of the handle section 22. Release buttons 24A are provided one on each of the left and right sides of the battery 24. By pressing both of the left and right release buttons 24A inward while pulling downward on the battery 24, an operator can remove the battery 24 from the battery connector 22A. A connecting member 29 having the external connection terminal (communication connector) 81 (see also FIG. 11) is fixed to the battery connector 22A with screws or the like. The microcomputer 78 of this embodiment also possesses an M16C/64 CPU.

The computer 103 is a common computer, such as a personal computer. The power cable 104 is a USB cable, for example. One end of the power cable 104 is connected to a USB port of the computer 103, while the other end is connected to a USB connector on the conversion device 106. The communication cable 105 is an RS232C (Recommended Standard) cable, for example. One end of the communication cable 105 is connected to an RS232C port of the computer 103, while the other end is connected to an RS232C connector of the conversion device 106. The conversion device 106 converts between the RS232C signal level and the signal level of the micro-computer 78. The conversion device 106 is provided with a transmission integrated circuit such as a bus transceiver (the MAX3221EAE in this embodiment). One end of the dedicated cable 108 is connected to the conversion device 106 (fixedly integrated, for example), while the other end is connected to the external connection terminal 81 of the power tool 201. The dedicated cable 108 is provided with four signal lines for reception (connected to the RD pin), power (connected to the Vcc pin), transmission (connected to the TD pin), and ground (connected to the GND pin).

By establishing the connections described above, the computer 103 can overwrite the control programs or the like written in the ROM of the microcomputer 78. Since the battery is removed from the power tool 201, the computer 103 supplies power to the microcomputer 78 (5V, for example) through the power cable 104, conversion device 106, dedicated cable 108, and the external connection terminal 81. The computer 103 transmits signals for overwriting programs in the microcomputer 78 via the communication cable 105, conversion device 106, dedicated cable 108, and the external connection terminal 81. Hence, one side of the cable connecting the computer 103 and the power tool 201 is constructed from includes two systems including a power supply system (the power cable 104) and a communication system (the communication cable 105).

The overwriting system 100 according to the second embodiment can obtain the following effects. Control programs or the like stored in the microcomputer 78 built into the housing 2 or a memory element provided with or built into the microcomputer 78 can be overwritten at a later date with programs and the like adapted to the customer's needs. In other words, by preparing various control programs or the like in demand by customers, this system provides a versatile power tool that can satisfy the needs of individual customers.

Further, the overwriting system 100 enables the computer 103 to transmit overwriting signals together with a power supply to the microcomputer 78 while the battery is removed from the body of the power tool 201, preventing the power tool 201 from being operated. Accordingly, the overwriting system 100 allows for the safe overwriting of control programs or the like in the microcomputer 78.

The CPU provided in the microcomputer 78 is the inexpensive M16C/64, making it possible to provide the power tool at a lower cost.

Since the conversion device 106 is provided outside the housing of the power tool 201 and is detachably connected to the power tool 201, this configuration reduces the number of parts that are added to the power tool 201 for overwriting control programs or the like in the microcomputer 78. Thus, this configuration is more cost-efficient than if the conversion device 106 were fixedly disposed inside the housing.

Since the computer 103 can supply power (5V) through the USB cable, there is no need to provide an adapter or other power supply circuit, but merely to provide a single dedicated cable, thereby making this configuration advantageous for reducing the number of parts and cost and increasing productivity. Further, a 5V power supply is very stable since it is universally used.

While the electronic pulse driver of the invention has been described in detail with reference to specific embodiments thereof, it would be apparent to those skilled in the art that many modifications and variations may be made therein without departing from the spirit of the invention, the scope of which is defined by the attached claims.

For example, in the first embodiment, four control modes are stored in the EEPROM 80 as drive modes, but the number of drive modes is not limited to four. Further, the drive modes are stored in the EEPROM 80 as numbers corresponding to these control modes, but the control modes themselves may be stored as the drive modes.

The dedicated cable 108 described in the second embodiment may possess five signal lines rather than four. The number of signal lines should be set based on the number of pins in the external connection terminal 81. The block diagram in FIG. 12 illustrates an overwriting system for overwriting control programs or the like when the dedicated cable 108 possesses five signal lines.

If the computer 103 is not equipped with an RS232C port, the configuration of the embodiments may be implemented using a USB-RS232C converter.

If the computer 103 has a built-in USB interface, a USB cable may be used as the communication cable. Alternatively, a single USB cable can be used to function as both the power cable and the communication cable.

A USB connector for the power supply may be provided separately from the external connection terminal 81, dividing the connecting means between two systems (a power supply system and a communication system) on the power tool 201 side.

The above embodiment may be applied to a wide variety of power tools and is not limited to fasteners and other power drivers, provided that operations are performed based on programs in a control unit.

In the above embodiment, the four drive modes are selected on the PC 82. However, the four drive modes may be selected on the main body 1A.

1. A power tool comprising:
a motor configured to be driven based on one of a plurality of drive modes;
a mode section switch;
a control portion configured to operate responsive to a first operation to assign one or more drive modes preselected from the plurality of drive modes to the mode selection switch, a second operation different from the first operation being capable of manipulating the mode selection switch to select one drive mode from the one or more preselected drive modes, the control portion being further configured to control the motor based on the one drive mode selected by the mode selection switch.

2. The power tool according to claim 1, wherein the first operation is configured to be executed on an external device connected to the power tool.

3. A power tool comprising:
a motor;
a bit drive portion configured to be driven by the motor to drive a bit;
a first storing portion configured to store a plurality of control modes for controlling the motor; and
a control portion configured to control the motor,
wherein the power tool further comprises a second storing portion configured to store one or more control modes selected from the plurality of control modes as one or more drive modes, and
the control portion is configured to control the motor based on one drive mode selected from the one or more drive modes stored in the second storing portion.

4. The power tool according to claim 3, further comprising a connection portion configured to be connectable to an external device to conduct communication between the power tool and the external device,
wherein the external device connected to the connection portion is configured to transmit one or more control modes selected from the plurality of control modes, and
wherein the second storing portion is configured to store the one or more control modes transmitted from the external device as the one or more drive modes.

5. A power tool comprising:
a housing;
a control portion accommodated in the housing; and
a connection unit including a cable that is configured to be connectable to an external overwriting unit to conduct communication between the control portion and the external overwriting unit,
wherein the connection unit is configured to connect the external overwriting unit with the control portion to execute both of power supply and signal transmission from the external overwriting unit to the control portion.

6. The power tool according to claim 5, wherein one side of the connection unit connected to the external overwriting unit comprises two systems including a power supply system and a communication system.

7. The power tool according to claim 6, wherein the power supply system comprises a USB cable.

8. The power tool according to claim 6, wherein the communication system comprises an RS232C cable.

9. The power tool according to claim 5, wherein the control portion comprises an M16C/64 CPU.

10. The power tool according to claim 5, wherein the connection unit comprises a conversion portion including a transmission integrated circuit.

11. The power tool according to claim 10, wherein the transmission integrated circuit is a bus transceiver.

12. The power tool according to claim 10, wherein the conversion portion is provided outside the housing.

13. The power tool according to claim 10, wherein the connection unit comprises a single cable connecting the conversion portion with the control portion, the single cable including one signal line for the power supply and another signal line for the signal transmission.

14. The power tool according to claim 11, wherein the housing is provided with a communication connector, the single cable being configured to be detachable with respect to the communication connector.

15. The power tool according to claim 10, wherein the connection unit comprises a cable connecting the conversion portion with the external overwriting unit, the cable comprising two systems including a power supply system and a communication system.

16. The power tool according to claim 5, wherein the connecting unit is configured to be detachable with respect to the housing.

17. An overwriting system comprising:
a power tool comprising:
a housing; and
a control portion accommodated in the housing;
a computer; and
a connection unit configured to connect the power tool with the computer to conduct communication between the computer and the control portion,
wherein the computer is configured to supply power to the control portion through the connection unit and to overwrite program used in the control portion or parameter in the program through the connection unit.

18. An overwriting method comprising:
connecting one end of a connection unit to a communication connector of a power tool including a control portion;
connecting another end of the connection unit to a computer to conduct communication between the computer and the control portion; and
supplying power from the computer to the control portion through the connection unit and overwriting program used in the control portion or parameter in the program through the connection unit.
